(19) United States
(12) Patent Application Publication
(10) Pub. No.: US 2006/0170359 A1
(43) Pub. Date: Aug. 3, 2006

(54) Electrode structure of planar lamp

(75) Inventors: Chin-Wen Chou, Hsin-Tien City (TW); Ying-Nan Cheng, Hsin-Tien City (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/047,672

(22) Filed: Feb. 2, 2005

(51) Int. Cl. H01J 61/04; H01J 17/04

(52) U.S. Cl. 313/631

(57) ABSTRACT

The present invention discloses an improved electrode structure of planar lamp, which applies to the planar lamp that has a gas-discharge cavity with at least a bending channel and with a discharge gas and a fluorescent material equipped thereinside. Via disposing an electrically conductive element, which traverses the bending channels, onto the discharge electrodes on the external wall of the gas-discharge cavity, the input area of the power output by the discharge electrodes is increased, and thus, the light uniformity of the planar lamp is achieved.

### FIELD OF THE INVENTION

The present invention relates to an improved electrode structure of planar lamp, particularly to one, wherein an electrically-conductive element that traverses the bending channels of the planar lamp is adopted to increase the input area of the power output by the discharge electrodes so as to achieve the light uniformity of the planar lamp.

### BACKGROUND OF THE INVENTION

What the planar fluorescent lamp lays most stress on is to achieve the uniform distribution of light, and the operational principle of the conventional planar gas-discharge lamp, which is used as the backlight source, is that with an inverter providing the power, the fluorescent material coated on the light-emitting side is excited to emit light via the means of gas (usually an inert gas) discharging. For the similar technology, please refer to R.O.C. Patent POublication No. 521300 “Dielectric Barrier-Type Discharge Lamp With Support Element Between Bottom Plate And Cover Plate”. According to the electrode design, the gas-discharge lamp can be divided into the external-electrode type (referring to FIG. 1) and the internal-electrode type, wherein a closed cavity is formed between the top-layer glass of the light-emitting face and the bottom-layer glass of the light-reflecting face and the closed cavity is filled with a reaction gas, and wherein a support portion is usually formed in the cross section of the top-layer glass, and wherein a fluorescent material is coated on the internal surface neighboring the light-emitting face and a reflective material, which can reflect the light propagating downward, is coated on the internal surface neighboring the light-reflecting face; in the external-electrode type gas-discharge lamp, the electrodes adhere to the external surface of the bottom-layer glass and an insulating layer is coated over the electrodes; in the internal-electrode type one, the electrodes are disposed inside the closed cavity, and a support element is used to separate the top-layer glass and the bottom-layer glass. Once receiving the power transformed by the inverter, the reaction gas inside the cavity will discharge and emit the ultraviolet ray to excide the fluorescent material to emit light.

In the external-electrode type planar gas-discharge lamp, in order not to influence discharge, the reflective material must be very thin; therefore, a portion of light emitted from the fluorescent material is apt to transmit through the light-reflecting face, and the insulating layer has no reflective ability, which further induces the light to leak from the light-reflecting face more seriously; thus, the light efficiency is influenced. Furthermore, as shown in FIG. 1, in both the internal-electrode type and the external-electrode type, the electrodes are usually disposed in both ends of the planar lamp; as the electrodes of both ends of the planar lamp have many bending channels, a higher initial voltage for discharge is needed in the portions of the sharp corners of bending channels; however, the light in some portions is still dim as the distance between the electrodes is too long.

### SUMMARY OF THE INVENTION

The primary objective of the present invention is to solve the aforementioned problem. The present invention adopts an electrically conductive element, which traverses the bending channels of the planar lamp, to increase the power-input area to enable every electrically conductive channel to create gas-discharge and excite the fluorescent material to emit light so that the light uniformity of the planar lamp can be achieved.

Another objective of the present invention is to realize the electrically-conductive element via applying an adhesive carbon-fiber patch with an electrically-conductive paste to the discharge electrodes in order to reduce the manufacture cost and promote the quality and the manufacture efficiency.

Still another objective of the present invention is to apply the present invention to a U-type tube lamp.

### BRIEF DESCRIPTION OF DRAWINGS

FIG. 1 is a schematic diagram showing the disposition of the conventional discharge electrodes of the planar lamp.

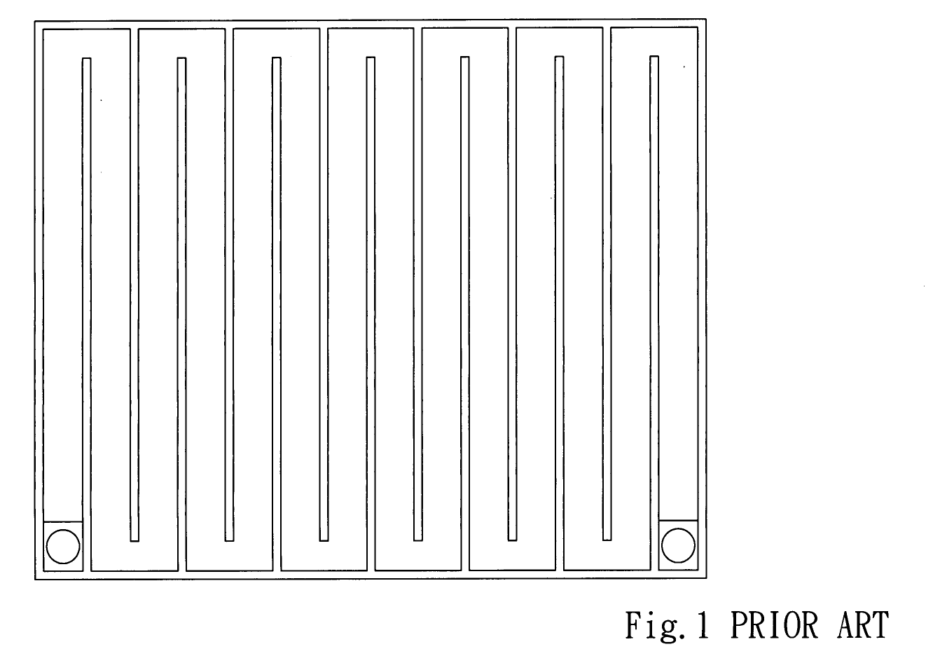

FIG. 2 is a schematic diagram showing the disposition of the present invention's discharge electrodes of the planar lamp.

FIG. 3 is a schematic sectional view along the line A-A.

FIG. 4 is a schematic diagram of a second embodiment of the present invention.

FIG. 5 is a schematic diagram of a third embodiment of the present invention.

FIG. 6 is a schematic diagram showing that the present invention applies to a U-type tube lamp.

### DETAILED DESCRIPTION OF THE PREFERRED EMBODIMENTS

In cooperation with the attached drawings, the detailed description and the technical contents of the present invention will be stated below.

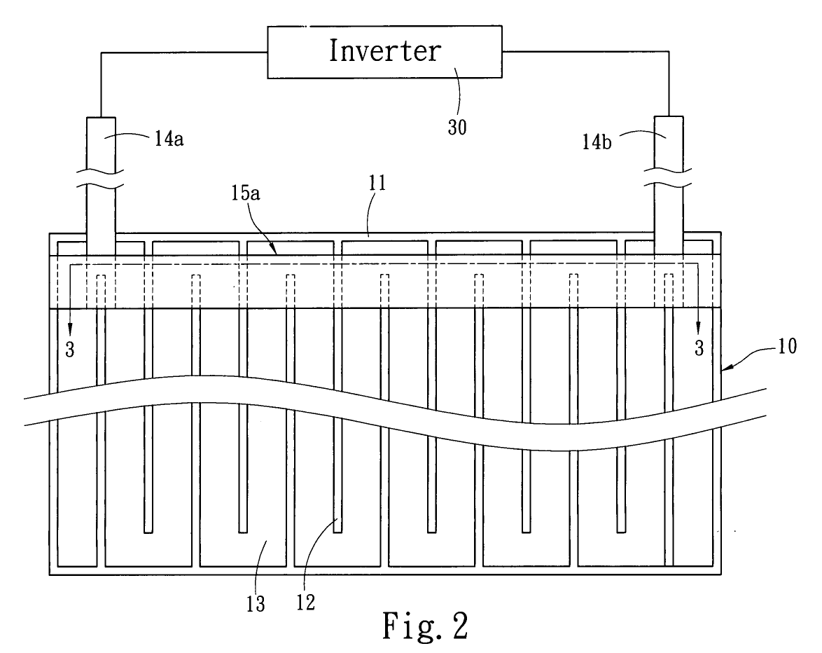

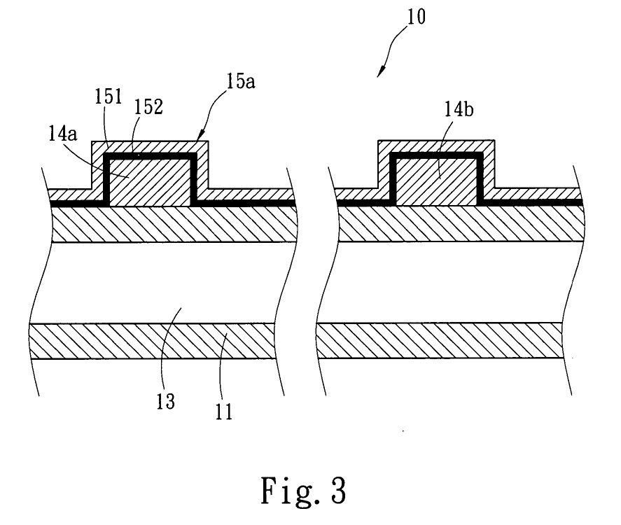

Refer to FIG. 2 and FIG. 3 schematic diagrams showing the disposition of the discharge electrode 14a and 14b of the planar lamp 10. The present invention applies to a planar lamp 10, which has a gas-discharge cavity 11 with at least one bending channel 13. The bending channel 13 can be formed via partitioning the interior of the gas-discharge cavity 11 with separators 12. The interior of the gas-discharge cavity 11 is equipped with a fluorescent material and a discharge gas, and metallic discharge electrodes 14a and 14b are disposed on the external wall of the gas-discharge cavity 11. The discharge electrodes 14a and 14b are electrically connected to an inverter 30. In the present invention, the discharge electrodes 14a and 14b are installed on the surface of at least one external wall of the gas-discharge cavity 11, and an electrically conductive element 15a, which traverse the bending channels 13, are further installed on the discharge electrodes 14a and 14b.

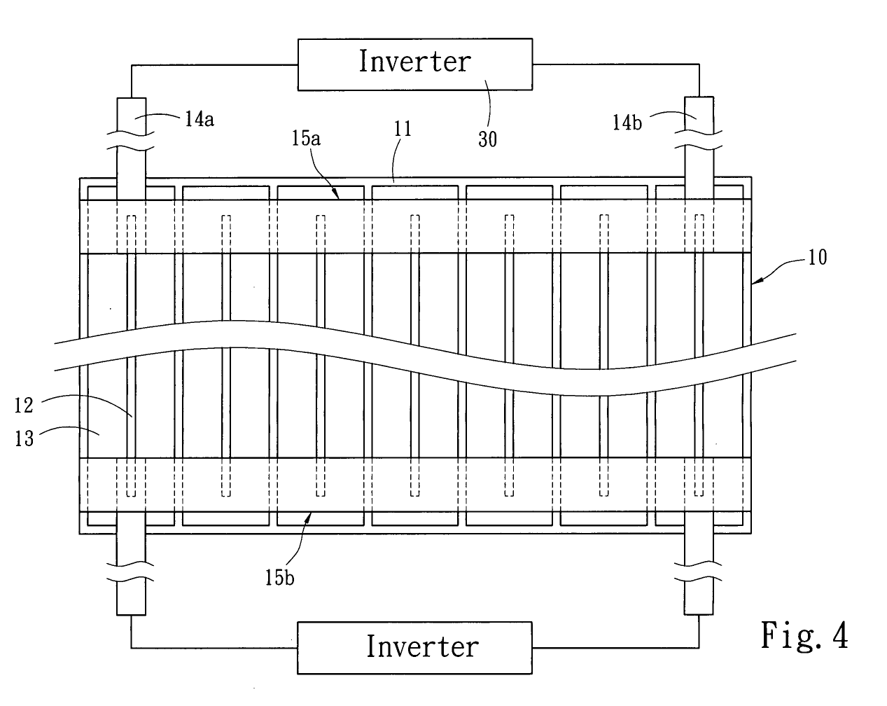

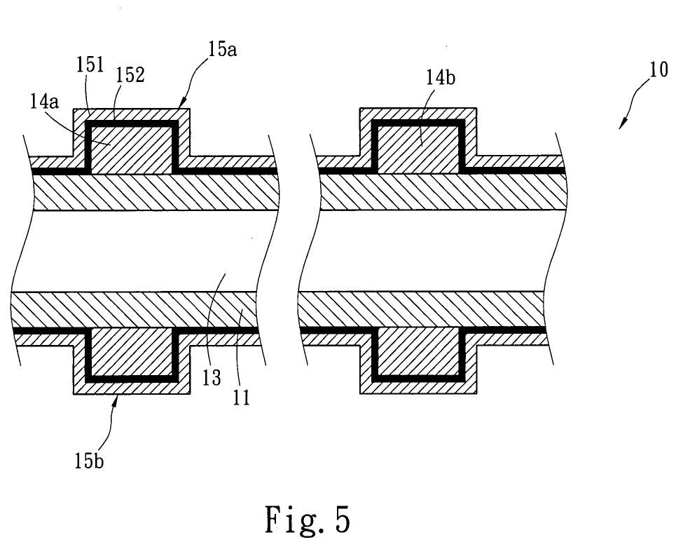

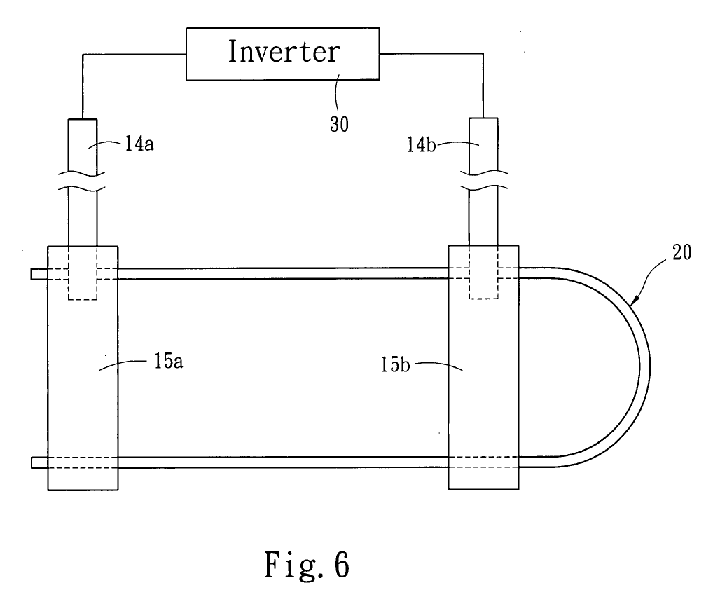

In FIG. 2 and FIG. 3, the discharge electrodes 14a and 14b, and the electrically conductive element 15a of the present invention are disposed on the upper end of the top surface of the gas-discharge cavity 11. In FIG. 4, the discharge electrodes 14a and 14b, and the electrically conductive element 15a of the present invention are disposed on both the upper end and the lower end of the top surface of the gas-discharge cavity 11. In FIG. 5, the discharge electrodes 14a and 14b, and the electrically conductive element 15 a of the present invention are disposed on both the upper end and the lower end of both the top surface and the bottom surface of the gas-discharge cavity 11. FIG. 6 shows that the present invention can also apply to U-type tube lamp 20. The number of the discharge electrodes 14a and 14b, and the electrically conductive element 15 a are dependent on the power provided by the inverter 30 and the size of the planar lamp 10. The electrically conductive element 15a of the present invention is formed of an adhesive carbon-fiber patch 152 with an electrically conductive paste 151; thus, the electrically conductive element 15a can be fabricated easily and applied to the discharge electrodes 14a and 14b conveniently. The way of inputting the power to the discharge electrodes 14a and 14b can adopt a unidirectional high-low potential mode or a bi-directional push-pull mode. It is obvious in all the embodiments that although the discharge electrodes 14a and 14b are separately disposed on either end of the planar lamp 10, owing to the present invention's electrically-conductive element 15a traversing every bending channel 13, each bending channel can also has gas discharge to excite the fluorescent material to emit light. Thus, the problem that the distance of the conventional discharge electrodes 14a and 14b is too long and the light is dim in some portions of the conventional planar lamp 10 with the bending channels can be solved. Therefore, the present invention can achieve the objective of the light uniformity of the planar lamp.

Those described above are only the preferred embodiments of the present invention and not intended to limit the scope of the present invention, and any equivalent modification and variation according to the claims of the present invention is to be included within the scope of the present invention.

What is claimed is:

1. An improved electrode structure of planar lamp,
wherein said planar lamp has a gas-discharge cavity with at least one bending channel, and
wherein the interior of said gas-discharge cavity is equipped with a fluorescent material and a discharge gas, and
wherein discharge electrodes are disposed on the external wall of said gas-discharge cavity;
characterized by:
said discharge electrodes are installed on the surface of at least one external wall of said gas-discharge cavity, and
an electrically conductive element, which traverses said bending channels, is installed on said discharge electrodes.

2. The improved electrode structure of planar lamp according to claim 1, wherein said electrically conductive element is an adhesive carbon-fiber patch with an electrically conductive paste.

3. The improved electrode structure of planar lamp according to claim 1, wherein said planar lamp can be a U-type tube lamp.

4. The improved electrode structure of planar lamp according to claim 1, wherein said discharge electrode is a metallic electrode.

5. The improved electrode structure of planar lamp according to claim 1, wherein said discharge gas is an inert gas.

6. The improved electrode structure of planar lamp according to claim 1, wherein said the interior of said gas-discharge cavity is partitioned by separators to form a plurality of bending channels.
